(19) United States
(12) Patent Application Publication
(10) Pub. No.: US 2026/0297477 A1
(43) Pub. Date: Oct. 1, 2026

(54) APPARATUS FOR AFFECTING CERTAIN CHARACTERISTICS OF WINE AND SPIRITS

(71) Applicant: VIRTUE WINE AND SPIRITS, Kennewick, WA (US)

(72) Inventors: Michael Colton, Kennewick, WA (US); Rodolfo Nicacio, Kennewick, WA (US)

(21) Appl. No.: 19/565,503

(22) Filed: Mar. 12, 2026

Related U.S. Application Data
(60) Provisional application No. 63/773,434, filed on Mar. 17, 2025.

(51) Int. Cl. C12H 1/16

(52) U.S. Cl. CPC C12H 1/165

(57) ABSTRACT

This disclosure relates to methods and systems for treating wines and spirits using electromagnetic induction. A method includes energizing a conduction ring to generate electromagnetic signals between about 50 kHz and 300 kHz and applying the signals such that the wine, spirit, or its vessel forms at least part of a secondary coil. The treatment improves organoleptic properties and/or inhibits microbial proliferation and may enhance heat treatment and aging acceleration. The electromagnetic signals may induce electric fields of about 1-5,000 V/cm and power levels of about 1-2,000 W, applied for about 1 second to 24 hours at various production stages from pre-fermentation to bottling. A corresponding system includes a conduction ring, an electrical signal source configured to energize the ring, and a secondary coil at least partially defined by the wine, spirit, or its vessel, and may include conductors, flexible magnetic transducers, and wireless drive circuitry.

### RELATED APPLICATIONS

This application claims the benefit of U.S. Provisional Patent Application No. 63/773,434, filed Mar. 17, 2025, titled “APPARATUS FOR AFFECTING CERTAIN CHARACTERISTICS OF WINE AND SPIRITS,” the entirety of the disclosure of which is hereby incorporated by this reference.

### TECHNICAL FIELD

This document relates to methods and apparatuses for altering characteristics of wine and spirits by application of low to mid-level frequency AC current electromagnetic signals to improve such properties as texture, aromatic balance, and astringency.

### BACKGROUND

The wine and spirits industry has long been synonymous with tradition and craftsmanship, where the quality and sensory characteristics of the final product are shaped by a complex interplay of factors, including grape variety, terroir, fermentation techniques, and aging processes. Each stage of production requires meticulous attention to detail, as even slight variations in temperature, humidity, or microbial activity can significantly impact the outcome. Winemakers and distillers devote years, sometimes decades, perfecting their methods to achieve a harmonious balance of flavors, aromas, and textures that distinguish their products in an increasingly competitive market. However, despite these efforts, the process of crafting wine and spirits remains fraught with challenges.

Microbial contamination is a persistent issue that can lead to spoilage, off-flavors, or unexpected deviations from a product's intended profile. Unwanted bacterial or yeast activity during fermentation or aging can introduce volatile compounds that compromise the quality of the final beverage. Similarly, factors such as excessive astringency, oxidation, and imbalanced aromatic profiles can render a product unpalatable or detract from its complexity. Traditional mitigation strategies, such as the use of sulfur dioxide in winemaking or filtration methods in distillation, can sometimes introduce additional concerns, including potential alterations to the sensory characteristics of the beverage or consumer health considerations.

Another pressing concern is the management of environmental influences, particularly the increasing prevalence of smoke taint due to wildfires in major wine-producing regions. Smoke exposure can introduce undesirable phenolic compounds that negatively impact a wine's aroma and taste. As a result, researchers and industry professionals are investigating novel filtration and chemical binding techniques to mitigate these effects without stripping the wine of its essential character.

Moreover, there is a growing demand for methods that can accelerate the aging process without sacrificing quality. Traditional aging in barrels or casks can take years to develop the desired depth and smoothness in spirits, making it a costly and time-consuming endeavor. Emerging approaches, such as ultrasound, rapid oxidation, and controlled-temperature maturation, offer promising alternatives that may allow producers to achieve comparable results in a fraction of the time.

With shifting consumer preferences and an increasing demand for premium, high-quality products, the need for advanced solutions in wine and spirits production has never been greater. Whether through biotechnology, precision fermentation, or controlled environmental manipulation, the industry is at a turning point where tradition must harmonize with innovation. By embracing new methodologies while respecting the artisanal nature of winemaking and distillation, producers can not only overcome existing challenges but also unlock new creative possibilities that elevate the quality and diversity of their offerings.

### SUMMARY

According to some embodiments, the present disclosure relates to a method of treating a wine or spirit, the method comprising positioning a vessel containing the wine or spirit relative to a conduction ring, energizing the conduction ring with an alternating electrical signal to create electromagnetic signals having a frequency in a range of 50 kHz to 300 kHz to generate a time-varying electromagnetic field, and applying the electromagnetic signals to the wine or spirit such that the time-varying electromagnetic field induces a voltage and/or current in a secondary coil comprising a conductive path that is at least partially defined by the wine or spirit and/or the vessel containing the wine or spirit, wherein the electromagnetic signals improve at least one organoleptic property of the wine or spirit.

According to some embodiments, the present disclosure relates to a method of managing microbial activity in a wine or spirit, the method comprising positioning a vessel containing the wine or spirit relative to a conduction ring, energizing the conduction ring with an alternating electrical signal to create electromagnetic signals having a frequency in a range of 50 kHz to 300 kHz to generate a time-varying electromagnetic field, and applying the electromagnetic signals to the wine or spirit such that the time-varying electromagnetic field induces a voltage and/or current in a secondary coil comprising a conductive path that is at least partially defined by the wine or spirit and/or the vessel containing the wine or spirit, wherein the electromagnetic signals inhibit or reduce proliferation of at least one microorganism associated with the wine or spirit.

Particular embodiments may comprise one or more of the following features. The organoleptic property may be appearance, nose, taste, mouthfeel, finish, texture, aromatic balance, astringency, oak integration, or smoke taint. Application of the electromagnetic signals to the wine or spirit may enhance heat treatment, aging acceleration, and microbial management of the wine or spirit. The electromagnetic signals may comprise oscillating fields that gradually influence chemical reactions and modify molecular interactions within the wine or spirit. The electromagnetic signals may be created with a transducer comprising a magnetically conductive material passing through the conduction ring. The magnetically conductive material may be flexible. The conduction ring may encircle at least a portion of the vessel, may be wrapped around the vessel, and/or the vessel may be positioned such that at least a portion of the vessel passes through an aperture of the conduction ring. In some embodiments, the conduction ring comprises a split or clamp-on magnetically conductive core. At least one conductor may form at least part of the secondary coil and may be immersed in the wine or spirit or coupled to the vessel containing the wine or spirit. The at least one conductor may pass through the conduction ring. The at least one conductor may be two wires, wherein a first wire of the at least two wires is connected to ground and passes through the conduction ring and a second wire of the at least two wires is attached to the vessel containing the wine or spirit or is immersed in the wine or spirit. Energizing the conduction ring may comprise generating and amplifying an electromagnetic signal with an amplifier and wirelessly transmitting the electromagnetic signal from a transmitter through an antenna to a receiver, wherein the receiver is conductively coupled to the conduction ring. Energizing the conduction ring may further comprise one or more of amplitude modulation, frequency sweep, phase modulation, and/or burst operation, including randomized and/or variable durations. In some embodiments, burst operation comprises bursts having randomized and/or pseudo-randomized durations and/or intervals between bursts. In some embodiments, energizing the conduction ring further comprises controlling duty cycle of the applied signal and/or bursts. In some embodiments, the frequency sweep spans at least 10 kHz within the about 50 kHz to about 500 kHz operating band. The method may further comprise sensing at least one parameter of the vessel and/or the wine or spirit and selecting at least one treatment parameter based on the sensed parameter. The method may further comprise inducing an electric field in the wine or spirit with an intensity from about 1 V/cm to about 5,000 V/cm. The electromagnetic signals may be applied to generate a power level in the wine or spirit from about 1 W to about 2,000 W. The method may further comprise applying the electromagnetic signals at pre-fermentation before yeast inoculation, at early fermentation, during active fermentation, during mid to late fermentation, at post-fermentation before aging or filtration, at aging and maturation stage, and/or at final processing and bottling. The method may further comprise applying the electromagnetic signals to the wine or spirit for an exposure duration of from about 1 second to about 24 hours. The wine may be red wine, white wine, rose wine, sparkling wine, fortified wine, dessert wine, natural wine, organic wine, biodynamic wine, ice wine, late harvest wine, dry wine, sweet wine, off-dry wine, still wine, orange wine, pét-nat (pétillant naturel) wine, table wine, noble rot wine, botrytized wine, carbonic maceration wine, crianza wine, reserva wine, gran reserva wine, varietal wine, blend wine, vintage wine, or non-vintage wine. The spirit may be whiskey, bourbon, Scotch whisky, Irish whiskey, rye whiskey, Canadian whisky, Japanese whisky, Tennessee whiskey, moonshine, brandy, Cognac, Armagnac, Calvados, Pisco, grappa, rum, white rum, dark rum, spiced rum, overproof rum, agricole rum, vodka, flavored vodka, gin, London Dry gin, Old Tom gin, Plymouth gin, genever, tequila, mezcal, sotol, raicilla, baijiu, soju, shochu, absinthe, aquavit, ouzo, arak, sambuca, liqueur, amaro, herbal liqueur, cream liqueur, fruit liqueur, nut liqueur, bitters, schnapps, anise-flavored spirits, aperitifs, or digestifs.

According to some embodiments, the present disclosure relates to a system for treating a wine or spirit, the system comprising a conduction ring, an electrical signal source coupled to energize the conduction ring with electromagnetic signals having a frequency in a range of 50 kHz to 300 kHz to generate a time-varying electromagnetic field, and a secondary coil configured to be at least partially formed by the wine or spirit and/or a vessel containing the wine or spirit, wherein the time-varying electromagnetic field is configured to induce a voltage and/or current in the secondary coil to expose the wine or spirit to induced electric fields and/or currents.

Particular embodiments may comprise one or more of the following features. The system may further comprise a support arrangement configured to position and retain the conduction ring relative to the vessel during treatment. In some embodiments, the support arrangement comprises a clamp, wrap, strap, adhesive member, or combinations thereof configured to retain the conduction ring around the vessel. The electromagnetic signals may be configured to improve at least one organoleptic property of the wine or spirit. The organoleptic property may be appearance, nose, taste, mouthfeel, finish, texture, aromatic balance, astringency, oak integration, or smoke taint. The electromagnetic signals may be configured to inhibit or reduce proliferation of at least one microorganism associated with the wine or spirit. The electromagnetic signals may be configured to enhance heat treatment, aging acceleration, and microbial management of the wine or spirit. The electromagnetic signals may be configured to use oscillating fields that gradually influence chemical reactions to modify molecular interactions within the wine or spirit. The electromagnetic signals may be created with a transducer comprising a magnetically conductive material passing through the conduction ring. The magnetically conductive material may be flexible. The conduction ring may be configured to encircle at least a portion of the vessel, may be configured to wrap around the vessel, and/or may define an aperture configured to receive at least a portion of the vessel. In some embodiments, the conduction ring comprises a split or clamp-on magnetically conductive core. At least one conductor may form at least part of the secondary coil and is configured to be immersed in the wine or spirit or coupled to the vessel containing the wine or spirit. The at least one conductor may pass through the conduction ring. The at least one conductor may be two wires, wherein a first wire of the at least two wires is connected to ground and passes through the conduction ring and a second wire of the at least two wires is configured to attach to the vessel containing the wine or spirit or be immersed in the wine or spirit. The electromagnetic signals may be configured to induce an electric field in the wine or spirit with an intensity from about 1 V/cm to about 5,000 V/cm. The electromagnetic signals may be configured to generate a power level in the wine or spirit from about 1 W to about 2,000 W. The electromagnetic signals may be applied at pre-fermentation before yeast inoculation, at early fermentation, during active fermentation, during mid to late fermentation, at post-fermentation before aging or filtration, at aging and maturation stage, and/or at final processing and bottling. The electromagnetic signals may be applied to the wine or spirit for an exposure duration of from about 1 second to about 24 hours.

The system may further comprise a controller configured to control one or more of amplitude, waveform, modulation, frequency sweep, burst timing, exposure duration, and power, and may further comprise one or more sensors configured to sense at least one parameter of the vessel and/or the wine or spirit and provide an input to the controller for selecting at least one treatment parameter. In some embodiments, the controller comprises one or more processors and memory storing instructions that, when executed, cause the controller to generate and/or control the drive signal for energizing the conduction ring. In some embodiments, the control functionality is implemented at least in part by a computer program product comprising instructions stored on a non-transitory computer-readable medium and executable by one or more processors of the controller. In some embodiments, the controller is configured to apply bursts having randomized and/or pseudo-randomized timing, durations, and/or intervals. Examples of sensed parameters include temperature, conductivity, pH, turbidity, dissolved oxygen, oxidation-reduction potential, and combinations thereof. The wine may be red wine, white wine, rosé wine, sparkling wine, fortified wine, dessert wine, natural wine, organic wine, biodynamic wine, ice wine, late harvest wine, dry wine, sweet wine, off-dry wine, still wine, orange wine, pét-nat (pétillant naturel) wine, table wine, noble rot wine, botrytized wine, carbonic maceration wine, crianza wine, reserva wine, gran reserva wine, varietal wine, blend wine, vintage wine, or non-vintage wine. The spirit may be whiskey, bourbon, Scotch whisky, Irish whiskey, rye whiskey, Canadian whisky, Japanese whisky, Tennessee whiskey, moonshine, brandy, Cognac, Armagnac, Calvados, Pisco, grappa, rum, white rum, dark rum, spiced rum, overproof rum, agricole rum, vodka, flavored vodka, gin, London Dry gin, Old Tom gin, Plymouth gin, genever, tequila, mezcal, sotol, raicilla, baijiu, soju, shochu, absinthe, aquavit, ouzo, arak, sambuca, liqueur, amaro, herbal liqueur, cream liqueur, fruit liqueur, nut liqueur, bitters, schnapps, anise-flavored spirits, aperitifs, or digestifs.

The foregoing and other aspects, features, and advantages will be apparent from the DESCRIPTION, DRAWINGS, and CLAIMS.

### BRIEF DESCRIPTION OF THE DRAWINGS

Implementations will hereinafter be described in conjunction with the appended DRAWINGS, where like designations denote like elements.

FIG. 1 depicts a configuration of the portable device, optionally grounded, emitting a specialized AC current that makes the wine or spirit the secondary coil to complete the system. In FIG. 1, the conductive core or ring comprises a flexible or rigid magnetic ferrite or other material that the vessel of wine or spirits passes through to act as a secondary coil. In this configuration, flexible material (i.e., padding) can be included to improve the ability of the ring to adapt to the shape of the vessel. There is also an optional secondary coil wire that can be added to connect to the vessel or be immersed in the fluid inside the vessel, optionally with a ground wire.

FIG. 2 depicts another configuration of the portable device emitting a specialized AC current that makes the wine or spirit the secondary coil to complete the system by attaching the secondary coil to the vessel or inserting it directly into the liquid. Adhesive can be used to form the material into a ring that wraps around the vessel.

FIG. 3 depicts a wireless configuration of the portable device. A signal is generated, and the amplitude may be modulated prior to transmission through an antenna. The signal is received through an antenna on the receiver. The signal is then processed through a mixer, a demodulator, and an amplifier before the output signal is produced and transmitted to the conduction ring.

### DETAILED DESCRIPTION

The following detailed description provides numerous specific details. Those skilled in the relevant arts understand that embodiments of the disclosure may be practiced without these specific details. The disclosure may also be practiced in different and alternative configurations.

Unless specifically noted, it is intended that the words and phrases in the specification and the claims be given their plain, ordinary, and accustomed meaning to those of ordinary skill in the applicable arts. The singular forms “a,” “an,” and “the” include plural referents unless the context clearly dictates otherwise. Thus, for example, a reference to “a step” includes a reference to one or more of such steps. The words “exemplary,” “example,” “embodiment,” or various forms thereof are used herein to mean serving as an example, instance, or illustration. Any aspect or feature described herein as “exemplary” or as an “example” is not necessarily to be construed as preferred or advantageous over other aspects or designs. The examples are provided solely for purposes of clarity and understanding and do not limit or restrict the disclosure. It is to be appreciated that a myriad of additional or alternate examples of varying scope could have been presented, but have been omitted for purposes of brevity.

Throughout the description and claims of this specification, the words “comprise” and “contain” and variations of the words, for example “comprising” and “comprises”, mean “including but not limited to”, and are not intended to (and do not) exclude other components.

When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

The present disclosure may be understood more readily by reference to the following detailed description taken in connection with the accompanying figures and examples, which form a part of this disclosure. It is to be understood that this disclosure is not limited to the specific materials, devices, methods, applications, conditions, or parameters described and/or shown herein, and that the terminology used herein is for the purpose of describing particular embodiments by way of example only and is not intended to be limiting of the claimed inventions. The term “plurality”, as used herein, means more than one.

### Application of Electromagnetic Signals to Wine and Spirits

Electric-field based processing techniques have been reported for beverages, including wine and spirits. One example is pulsed electric field (PEF) processing, which applies electrical pulses using electrodes to expose a liquid to relatively high electric field strengths. Such approaches have been described as affecting extraction of compounds, microbial activity, and/or certain aspects of maturation.

PEF and similar electrode-based techniques typically rely on direct application of electric fields within the liquid and may involve high-voltage equipment, electrode contact, and process conditions that can be sensitive to vessel geometry, conductivity, and handling requirements.

In contrast, and as described below, the present disclosure is directed to applying time-varying electromagnetic signals to wine and spirits using a conduction ring that generates a field which couples energy into a secondary conductive path associated with the vessel and/or the liquid, rather than applying high-voltage pulses directly through electrodes in the liquid.

The present disclosure is directed to energizing a conduction ring with an alternating electrical signal (for example, having a frequency in a range of about 50 kHz to about 300 kHz) to generate a time-varying electromagnetic field. In embodiments, the time-varying field inductively couples energy into a secondary conductive path that is at least partially defined by the vessel and/or the wine or spirit, thereby exposing the wine or spirit to induced electric fields and/or currents without requiring high-voltage pulsed electrode treatment of the liquid.

In some embodiments, the secondary conductive path includes one or more conductors and/or electrodes coupled to the vessel and/or positioned relative to the wine or spirit, while in other embodiments the coupling is provided without immersed electrodes.

Without wishing to be bound by theory, the induced fields and/or currents may influence one or more processes in the wine or spirit, including chemical reactions and equilibria that contribute to maturation and flavor development. In some embodiments, the time-varying electromagnetic signals may affect fermentation-related behavior (for example, yeast metabolism) and/or reduce or inhibit microbial proliferation, depending on treatment parameters and the beverage composition.

Important differences between PEF-type techniques and the disclosed approaches include that PEF generally applies short, high-voltage pulses to establish high electric field strengths in the liquid (often using electrodes), which can produce immediate electroporation-type effects. In contrast, the disclosed approaches apply alternating electromagnetic signals (e.g., tens to hundreds of kHz) via the energized conduction ring to provide inductive coupling into the secondary conductive path, which may be implemented with reduced handling complexity and may be compatible with a variety of vessel configurations.

### Devices, Apparatuses, and Systems for Applying the Electromagnetic Signals

In certain aspects, the present disclosure provides a portable device 100 comprising a transducer 102 that emits a specialized AC current and makes a vessel containing the wine or spirits 104 the secondary coil to complete the circuit. As used herein, a “secondary coil” may refer to a conductive path formed by the vessel containing the beverage, the beverage itself, and/or one or more conductors coupled to the vessel or beverage, which conductive path is configured to receive energy from the energized conduction ring and thereby couple electromagnetic energy into the beverage. The vessel may be, for example, a bottle, carboy, tank, barrel, cask, or other container used for fermentation, storage, aging, transport, or bottling. The vessel may comprise glass, stainless steel, oak, polymeric material, ceramic, or combinations thereof.

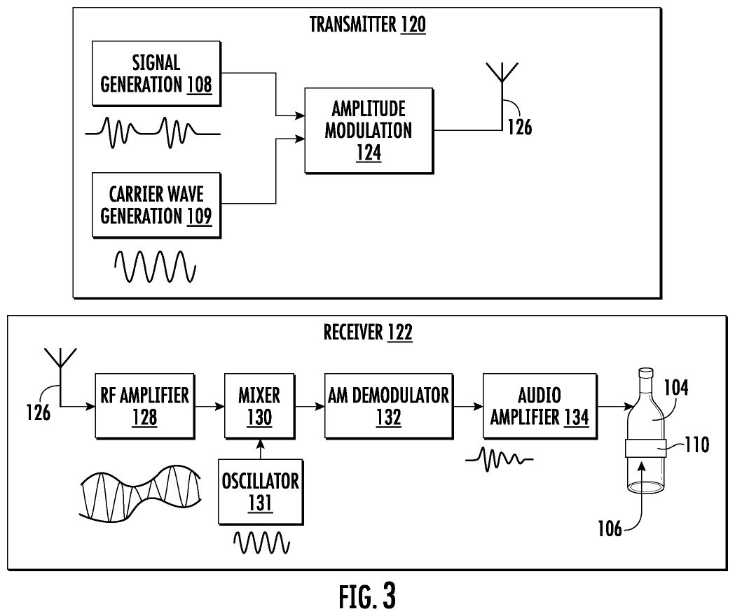

In one aspect, the transducer comprises a magnetically conductive material which passes through a conduction ring 106. The conduction ring 106 is energized by an electrical signal generated by an AC voltage generator 108 (see FIG. 3). In some embodiments, the electrical signal is communicated via a carrier wave 109. The conduction ring 106 may be rigid and may include padding 110 to make the conduction ring 106 more adjustable to fit around the vessel of wine or spirits 104. In some embodiments, the conduction ring is toroidal or annular and comprises a ferrite core. In one aspect, the conduction ring 106 may be coupled with a flexible ferrite. In some embodiments, the conduction ring comprises one or more electrically conductive windings disposed around a magnetically conductive core, such as a ferrite core, to generate the time-varying electromagnetic field when driven by the alternating electrical signal.

In one aspect illustrated in FIG. 3, a signal transmitter 120 communicates the signal wirelessly with a receiver 122 to produce the specialized AC current in the conduction ring 106. The signal is initially generated and amplified by an amplifier 124. The signal is then transmitted from the transmitter 120 through an antenna 126. The signal is received by the receiver 122 that directs the signal to an amplifier 128 and mixer 130. The mixer 130 may be coupled to an oscillator 131. The amplifier 128 and mixer 130 then transmit the signal to a demodulator 132. The demodulator 132 processes the signal, and the signal is then transmitted to an audio amplifier 134 that produces the final output signal that is then transmitted to the conduction ring 106.

In one embodiment, the conduction ring 106 may be connected with or inserted into the vessel containing the wine or spirits 104. In another aspect, the conduction ring 106 may be connected to or inserted into the vessel containing the wine or spirits 104 through a wire 116 and an adhesive pad 138.

In another aspect, the signal is generated and is transmitted through a wire 116 to the conduction ring.

In one aspect, the signal is a low to mid-level frequency AC current (e.g., 80 to 250 kHz) that has a modulating amplitude frequency and random duration. In another aspect, the signal may be modulated by a frequency modulator to adjust the low to mid-level frequency AC current based on the target's peak cytotoxic frequencies (PCF) before the signal is transmitted to the conduction ring. As used herein, peak cytotoxic frequencies refer to frequencies or frequency ranges selected to produce a desired inhibitory or cytotoxic effect on one or more target microorganisms. In some embodiments, amplitude modulation is applied using a modulation frequency in an audio-frequency range. In some embodiments, the frequency sweep spans at least 10 kHz within the about 50 kHz to about 500 kHz operating band. The alternating electrical signal may have any suitable waveform, including sinusoidal, square, pulsed, multi-tone, or combinations thereof.

In certain aspects, the method for transmitting the electromagnetic field is twofold, explained in more detail below. In some embodiments, the method for transmitting the electromagnetic field comprises just one of the two methods described below.

Primary Method of Transmission—The conduction ring 106 is wrapped around the vessel containing the wine or spirits 104. This turns the vessel containing the wine or spirits 104 into the secondary coil of the system.

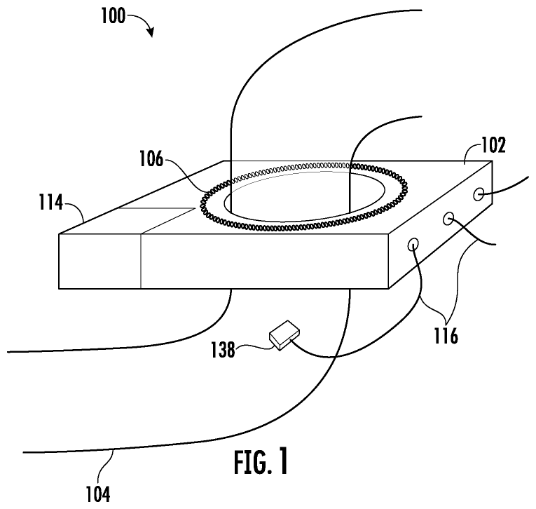

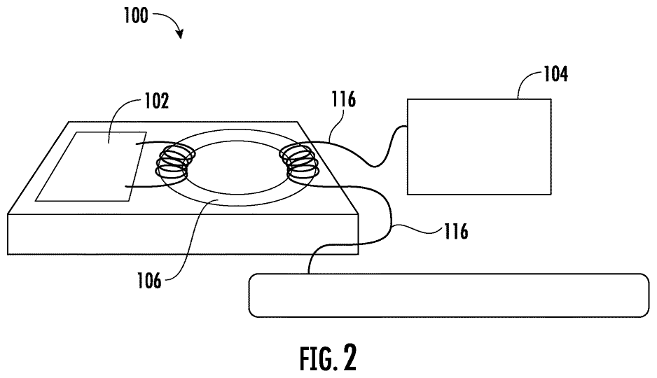

Secondary Method of Transmission—There are also one or more wires 116 that are passed through the conduction ring 106 and are placed with adhesive pads 138 placed around or inserted into the vessel containing the wine or spirits 104, as shown in FIGS. 1 and 2, that enhance the existing signal that is already propagating in the wine or spirits. These wires may or may not be grounded. The one or more wires 116 can be wrapped around the conduction ring 106 once or many times to enhance voltage emission. These wires 116 can be used with the portable device 100 attached to the vessel containing the wine or spirits or with the portable device 100 placed externally to the vessel containing the wine or spirits. These wires may or may not be grounded. In some embodiments, a resistor may be attached to a first wire 116 connected to the vessel containing the wine or spirits at a first site and a second wire 116 connected at a second site. In some embodiments, this resistor may be a rheostat. These wires may or may not be grounded.

In some embodiments, at least two conductors or wires 116 form at least part of a secondary coil for coupling energy from the energized conduction ring into the wine or spirit. In one example, a first conductor 116 is connected to a ground and passes through the conduction ring 106, and a second conductor 116 is coupled to a vessel containing the wine or spirit or is immersed in the wine or spirit. In such embodiments, the wine or spirit (including liquid in the vessel) provides at least part of the secondary coil path for transmission of the electromagnetic signals within the wine or spirit. In some embodiments, a first conductor is coupled to a reference potential, such as ground, and a second conductor is coupled to the vessel, immersed in the wine or spirit, and/or positioned in proximity to the wine or spirit.

In some aspects, the conduction ring 106 may not be wrapped around the vessel containing the wine or spirits and instead may only be connected to or inserted into the vessel containing the wine or spirits 104 through the one or more wires 116. These wires may or may not be grounded.

In some embodiments, increased intensity and directionality of the electrical signal is accomplished by wrapping the wire 116 around the conduction ring 106 multiple times. One or multiple outputs may be utilized. Connections to the vessel containing the wine or spirits may be made using one or multiple sites on the exterior or interior of the vessel. In some embodiments, the wire may be grounded via earth ground or other ground, as shown in FIG. 2.

In some embodiments, the device 100 includes a power source such as a battery 114 that provides electrical power to one or more components of the device, including the signal generator, AC voltage generator, amplifier(s), modulator, transmitter/receiver circuitry, meter/display, and/or the conduction ring 106. The battery 114 may be any suitable battery technology (e.g., rechargeable or non-rechargeable), may be removable or integrated into the housing, and may include one or more battery cells arranged in series and/or parallel to provide a desired voltage and/or current. In other embodiments, the device 100 may be powered by an external power source, such as a wall power adapter, transformer, regulated power supply, USB power source, or other wired power input, with or without internal energy storage. In still other embodiments, the device 100 may include power management circuitry (e.g., voltage regulation, charging circuitry, and/or over-current/over-temperature protection) configured to condition power from the battery 114 and/or external power source to operate the device and generate the electromagnetic signals described herein.

In some embodiments, the device 100 does not have a battery 114. Instead, the device 100 has an electrical plug configured to plug into an electrical outlet. The device 100 thus is effectively grounded by the electrical outlet when plugged in. The ground can be an earth ground or other ground. In such an embodiment, the conduction ring 106 may be connected to the vessel containing the wine or spirits 104 through a wire 116. The connection to the vessel containing the wine or spirits may be at one or multiple sites. Connections to the vessel containing the wine or spirits may be made using one or more outputs. In one aspect, a split wire is wrapped in opposite directions around the conduction ring before attaching to two sites on the vessel containing the wine or spirits.

In another embodiment, the one or more wires 116 is attached to a grounded item, preferably a grounding sheet or mat. The other end of the one or more wires 116 is connected to a grounded outlet, preferably a grounded 110V outlet, and the ground wire is the only wire connected to the grounded outlet, i.e., power wires may or may not be connected to the same outlet. In one embodiment, the conduction ring 106 wraps around the vessel containing the wine or spirits 104 and the one or more wires 116 is connected to a grounding sheet or mat.

The device 100 may comprise a voltmeter at the point of attachment. For example, the volt or power or wave form screen meter may be at the end of the wire 116 where the wire 116 attached to the vessel containing the wine or spirits 104. In another example, C, the volt or power or wave form screen meter is located where the wire 116 attaches to the grounded item, such as the grounding mat shown. In some aspects, the device 100 has a split ground wire wrapping in opposite directions around the conduction ring before connecting to the same grounding device.

In some embodiments, the apparatus can use an AC wall power supply (like or similar to a cell phone charger) or one or multiple batteries (such as lithium batteries) arranged in series for mobility. Rechargeable batteries can be used with the device. In certain embodiments, the unit has an output between 12-18 volts and 2.0-0.5 amps.

In some embodiments, the apparatus is 2-4 inches, 3-3.5 inches or 3.25 inches wide and 3-5, 3.5-4.5 or 4.25 inches in length. A grounding plate of appropriate size for the unit can be utilized. In one example, an aluminum grounding plate (4″×2.5″ and 1/16″ thick) is part of the unit. The grounding unit can attach to a ground wire from the coil wrap or ferrite bar.

### Electromagnetic Signal Application Parameters

In certain aspects, the electromagnetic signals that are used are alternating fields having frequencies that are in the range from about 50 kHz to about 500 kHz, and preferably from about 80 kHz to about 300 kHz. In certain aspects, the frequencies are in the range from about 50 kHz to 500 kHz, from about 50 kHz to 450 kHz, from about 50 kHz to about 400 kHz, from about 50 kHz to about 350 kHz, from about 50 kHz to about 300 kHz, from about 50 kHz to about 250 kHz, from about 50 kHz to about 200 kHz. In other aspects, the frequencies are in the range from about 100 kHz to about 500 kHz, from about 100 kHz to about 400 kHz, from about 100 kHz to about 300 kHz, or from about 100 kHz to about 200 kHz. In yet other aspects, the frequencies are in the range from about 150 kHz to about 500 kHz, from about 150 kHz to about 400 kHz, from about 150 kHz to about 300 kHz, or from about 150 kHz to about 200 kHz.

In other aspects, the electromagnetic signal induces an electric field in the liquid of the wine or spirits. In one aspect, the intensity of this electric field is from about 1 V/cm to about 5,000 V/cm, from about 1 V/cm to about 4,500 V/cm, from about 1 V/cm to about 4,000 V/cm, from about 1 V/cm to about 3,500 V/cm, from about 1 V/cm to about 3,000 V/cm, from about 1 V/cm to about 2,500 V/cm, from about 1 V/cm to about 2,000 V/cm, from about 1 V/cm to about 1,500 V/cm, from about 1 V/cm to about 1,000 V/cm, or from about 1 V/cm to about 500 V/cm. In another aspect, the intensity of this electric field is from about 500 V/cm to about 5,000 V/cm, from about 500 V/cm to about 4,500 V/cm, from about 500 V/cm to about 4,000 V/cm, from about 500 V/cm to about 3,500 V/cm, from about 500 V/cm to about 3,000 V/cm, from about 500 V/cm to about 2,500 V/cm, from about 500 V/cm to about 2,000 V/cm, from about 500 V/cm to about 1,500 V/cm, or from about 500 V/cm to about 1,000 V/cm.

In some aspects, the electromagnetic signals are applied to generate a power level in the wine or spirit of from about 1 W to about 2,000 W, from about 1 W to about 1,500 W, from about 1 W to about 1,000 W, from about 1 W to about 500 W, from about 1 W to about 400 W, from about 1 W to about 300 W, from about 1 W to about 200 W, from about 1 W to about 100 W, from about 1 W to about 50 W, from about 1 W to about 25 W, or from about 1 W to about 10 W.

In yet other aspects, the electromagnetic signals are applied to the wine or spirits for an exposure duration of from about 1 second to about 24 hours, from about 1 second to about 20 hours, from about 1 second to about 16 hours, from about 1 second to about 12 hours, from about 1 second to about 8 hours, from about 1 second to about 4 hours, from about 1 second to about 1 hour, from about 1 second to about 50 minutes, from about 1 second to about 40 minutes, from about 1 second to about 30 minutes, from about 1 second to about 20 minutes, from about 1 second to about 10 minutes, from about 1 second to about 5 minutes, or from about 1 second to about 1 minute.

The electromagnetic signals can be applied at multiple stages throughout the fermentation process in wine and spirits production, each serving a different purpose to enhance quality, control microbial activity, or accelerate maturation. Before fermentation begins, electromagnetic signals can be applied to grape must or raw materials to improve the extraction of phenolic compounds, tannins, and aromatic precursors. This enhances color, flavor, and mouthfeel while potentially reducing the need for extended maceration. At the start of fermentation, during the yeast lag phase, applying electromagnetic signals can help control microbial populations by selectively inhibiting spoilage organisms or enhancing beneficial yeast activity. This is particularly useful for reducing unwanted bacteria and wild yeasts without relying on chemical additives.

During active fermentation, electromagnetic signals may be used to modulate yeast metabolism, influencing sugar conversion rates and byproduct formation. This can lead to enhanced ester production, affecting aromatic complexity, or help regulate fermentation speed. In the mid-to-late stages of fermentation, electromagnetic signal applications can be utilized to reduce undesirable compounds such as volatile acidity, hydrogen sulfide, or off-flavors caused by stress in yeast populations. The controlled use of electromagnetic signals at this stage can also influence the balance of alcohol and other volatile compounds, ensuring a more refined final product.

After fermentation, electromagnetic signals can assist in microbial stabilization, reducing spoilage organisms and ensuring the wine or spirit remains free from contamination. This can serve as an alternative to traditional pasteurization methods, preserving the delicate flavors of the beverage. During the aging and maturation stage, electromagnetic signals can be used to accelerate aging in both wine and spirits. By enhancing oxidation, esterification, and oak extraction, these methods mimic the effects of long-term barrel aging in a much shorter period. Just before bottling, electromagnetic signals can be used for final microbial control and quality enhancement, ensuring stability while refining texture, balance, and aromatic composition. Each of these applications offers a unique way to improve fermentation efficiency, flavor development, microbial control, and aging acceleration.

In some embodiments, application of the mid-level frequency electromagnetic signals is used in conjunction with heat treatment of the wine or spirit. For example, the electromagnetic signals may be applied before, during, or after heating to enhance heat treatment, including by improving uniformity of heating and/or reducing time required to achieve a desired thermal processing outcome, while also providing microbial management and/or aging acceleration benefits.

### Effects of the Electromagnetic Signals on Microorganisms and Fermentation

Wine and spirits may contain, or may be exposed to, microorganisms during production, storage, and handling, including yeasts and bacteria. In certain embodiments, the time-varying electromagnetic signals disclosed herein may be applied to a wine or spirit to influence microorganism activity and/or proliferation and/or to influence fermentation-related behavior, depending on treatment parameters and beverage composition.

By way of example, microorganisms relevant to winemaking and spirit production can include yeast species used for fermentation and spoilage organisms, such as bacteria and wild yeasts. In some embodiments, the disclosed treatment is applied as a stabilization step before bottling and/or during aging, while in other embodiments the disclosed treatment is applied during fermentation to influence fermentation kinetics and/or metabolic outputs.

Without wishing to be bound by theory, energizing the conduction ring induces electric fields and/or currents within the vessel and/or beverage via inductive coupling into a secondary conductive path. The induced fields and/or currents may affect microorganism behavior by influencing membrane potentials, ion gradients, transport across cell membranes, and/or other electrochemical conditions in the beverage. As used herein, the “secondary conductive path” or “secondary coil” may comprise any conductive path in which current is induced by the time-varying electromagnetic field, including a path defined at least in part by the vessel wall, the beverage, and/or one or more conductors positioned relative to the vessel and/or beverage.

In some embodiments, treatment parameters (including frequency, waveform, modulation, duty cycle, exposure duration, and/or power) are selected to reduce or inhibit proliferation of microorganisms and/or to promote microbial stabilization of the beverage while limiting bulk heating. In some embodiments, the disclosed treatment achieves a desired microbial, maturation, and/or organoleptic effect while limiting bulk heating of the wine or spirit relative to a heat treatment condition that may otherwise be used to pursue a similar effect. In some embodiments, treatment parameters are selected to influence yeast metabolism during fermentation and thereby affect one or more fermentation outcomes, including production of aromatic compounds and/or fermentation rate.

The magnitude and distribution of the induced fields and/or currents within the beverage can depend on factors including vessel geometry and material, beverage conductivity and composition, temperature, and configuration of the conduction ring relative to the vessel. Accordingly, different beverages, vessels, and microorganism populations may exhibit different responses to a given set of treatment parameters.

In certain embodiments, the disclosed treatment may be used alone or in combination with other processing steps (for example, racking, filtration, oxygen management, contact with wood, or use of wood alternatives) to achieve a desired maturation profile and/or microbiological stability.

When this type of system is subjected to the present electrical fields, most of the lines of the electric field and currents tend away from the cells because of the highly resistive cell membrane and therefore the lines remain in the extracellular conductive medium. In the above recited frequency ranges, the actual fraction of electric field or currents that penetrates the cells is a strong function of the frequency.

In certain aspects, passage of the electric field through the dividing cells in late anaphase or telophase transforms the electric field into a non-homogeneous electric field that produces an increased density electric field in a region of a cleavage furrow of the dividing cells, and the electric field has amplitude and frequency characteristics such that application of the electric field prevents the cells from completing mitosis and cell division.

### Wine and Spirits

The methods, apparatuses, devices, and systems of the present disclosure can be applied to a variety of wine and spirits. These include but are not limited to the following types and classifications of wine and spirits.

Wine is broadly classified into red, white, rosé, sparkling, and fortified wines. Red wines, such as Cabernet Sauvignon, Merlot, and Pinot Noir, derive their color and tannins from grape skins during fermentation, while white wines, including Chardonnay, Sauvignon Blanc, and Riesling, are made from either white grapes or red grapes with skins removed. Rosé wines, like Provence Rosé and White Zinfandel, are created through limited skin contact to achieve a pink hue. Sparkling wines, including Champagne, Prosecco, and Cava, undergo secondary fermentation to produce carbonation. Fortified wines, such as Port, Sherry, and Madeira, have added spirits like brandy to increase alcohol content and longevity.

Spirits, also known as distilled beverages, are categorized by their base ingredients and production methods. Whiskey (or whisky) includes subcategories such as Scotch whisky, Irish whiskey, bourbon, and rye, each defined by its grain composition, aging process, and regional regulations. Brandy, distilled from fermented fruit juice, includes Cognac and Armagnac from France, as well as fruit brandies like Calvados (apple brandy). Rum, made from sugarcane byproducts like molasses, is classified into light, dark, spiced, and overproof varieties. Gin, known for its juniper-forward flavor, includes London Dry, Old Tom, and New Western styles. Vodka, typically distilled from grains or potatoes, is characterized by its neutrality and smoothness. Tequila and mezcal, both distilled from agave, differ in their production methods, with tequila often produced from blue agave and mezcal featuring a smoky flavor due to its roasting process. Liqueurs, such as Amaretto, Baileys, and Grand Marnier, are spirits infused with flavors like fruit, herbs, and cream.

In one aspect, the wine treated with the methods, apparatus, device or system is red wine, white wine, rose wine, sparkling wine, fortified wine, dessert wine, natural wine, organic wine, biodynamic wine, ice wine, late harvest wine, dry wine, sweet wine, off-dry wine, still wine, orange wine, pét-nat (pétillant naturel) wine, table wine, noble rot wine, botrytized wine, carbonic maceration wine, crianza wine, reserva wine, gran reserva wine, varietal wine, blend wine, vintage wine, or non-vintage wine.

In another aspect, the spirit treated with the methods, apparatus, device or system is whiskey, bourbon, Scotch whisky, Irish whiskey, rye whiskey, Canadian whisky, Japanese whisky, Tennessee whiskey, moonshine, brandy, Cognac, Armagnac, Calvados, Pisco, grappa, rum, white rum, dark rum, spiced rum, overproof rum, agricole rum, vodka, flavored vodka, gin, London Dry gin, Old Tom gin, Plymouth gin, genever, tequila, mezcal, sotol, raicilla, baijiu, soju, shochu, absinthe, aquavit, ouzo, arak, sambuca, liqueur, amaro, herbal liqueur, cream liqueur, fruit liqueur, nut liqueur, bitters, schnapps, anise-flavored spirits, aperitifs, or digestifs.

### Organoleptic Properties of Wine and Spirits

The methods, apparatus, device, and system disclosed herein can improve any one of a number of organoleptic properties in wine and spirits. These include but are not limited to appearance, aroma (aka nose), taste (aka palate), mouthfeel, and finish (aka aftertaste).

Appearance is the first indicator of quality, assessed through color, clarity, and viscosity. In wine, color can reveal age and grape variety, with reds evolving from deep ruby to garnet over time, while whites shift from pale yellow to golden. Spirits, especially aged varieties like whiskey and brandy, take on hues from light amber to deep mahogany due to barrel aging, with viscosity indicating body and alcohol content. Aroma, or the nose, is one of the most crucial aspects of both wine and spirits, offering primary, secondary, and tertiary scents. In wine, primary aromas derive from grapes (fruit, floral, or herbal notes), secondary aromas develop from fermentation (yeasty, buttery, or nutty characteristics), and tertiary aromas emerge with aging (oak, spice, tobacco, leather). In spirits, aroma complexity is shaped by ingredients, distillation, and maturation, presenting notes such as vanilla, caramel, smoke, spice, or botanicals, depending on the spirit type.

Taste, or the palate, involves the balance of fundamental flavors, including sweetness, acidity, bitterness, umami, and tannins. Wine relies on acidity to provide freshness, tannins for structure, and residual sugar for balance, while spirits incorporate varying levels of sweetness, bitterness, and spice, influenced by aging and alcohol content. The way these elements interact determines depth and harmony. Mouthfeel describes texture and body, affecting how the drink is perceived in terms of weight, smoothness, and astringency. Wines can be light, crisp, velvety, or full-bodied, while spirits can range from silky and oily to fiery and sharp, depending on alcohol strength and distillation methods. Lastly, finish, or aftertaste, is the lingering impression left after swallowing, which can be short and crisp or long and evolving. In high-quality wine and spirits, a complex and well-structured finish enhances the overall experience, leaving lasting notes of fruit, oak, spice, or warmth from alcohol.

Beyond appearance, aroma, taste, mouthfeel, and finish, other essential factors contribute to the complexity and refinement of these beverages. Texture affects the way a drink feels on the palate, ranging from silky and smooth to rough and drying, influencing the perception of balance and body. Aromatic balance ensures that no single note dominates, allowing fruit, spice, floral, and other components to harmonize for a well-rounded experience. Astringency, primarily influenced by tannins in wine and barrel-aging in spirits, contributes to structure and mouthfeel but must be well-integrated to avoid harshness. Oak integration is particularly important in aged wines and spirits, as oak-derived compounds such as vanillin, lactones, and tannins contribute to complexity, mouthfeel, and depth when balanced correctly. Smoke taint, a growing concern due to environmental factors, can introduce unpleasant aromas and flavors into wine, making its mitigation a crucial aspect of modern winemaking. The industry is also moving towards lowering or eliminating excessive interventions, particularly in controlling undesirable microbes, as natural and minimal-intervention approaches gain popularity for their ability to preserve authenticity and terroir.

Also contemplated are wines and spirits treated by the methods disclosed herein, including treated wines or spirits having one or more modified organoleptic properties and/or altered microbial profiles relative to an untreated counterpart.

More specifically, this disclosure, its aspects and embodiments, are not limited to the specific material types, components, methods, or other examples disclosed herein. Many additional material types, components, methods, and procedures known in the art are contemplated for use with particular implementations from this disclosure. Accordingly, for example, although particular implementations are disclosed, such implementations and implementing components may comprise any components, models, types, materials, versions, quantities, and/or the like as is known in the art for such systems and implementing components, consistent with the intended operation.

Many additional implementations are possible. Further implementations are within the CLAIMS.

It will be understood that implementations of the preceding disclosure include but are not limited to the specific components disclosed herein, as virtually any components consistent with the intended operation may be utilized. Accordingly, for example, it should be understood that, while the drawings and accompanying text show and describe particular implementations, any such implementation may comprise any shape, size, style, type, model, version, class, grade, measurement, concentration, material, weight, quantity, and/or the like consistent with the intended operation.

The concepts disclosed herein are not limited to the specific embodiments shown herein. For example, it is specifically contemplated that the components included in particular embodiments may be formed of any of many different types of materials or combinations that can readily be formed into shaped objects and that are consistent with the intended operation of the disclosure. For example, the components may be formed of: rubbers (synthetic and/or natural) and/or other like materials; glasses (such as fiberglass), carbon-fiber, aramid-fiber, any combination therefore, and/or other like materials; elastomers and/or other like materials; polymers such as thermoplastics (such as ABS, fluoropolymers, polyacetal, polyamide, polycarbonate, polyethylene, polysulfone, and/or the like, thermosets (such as epoxy, phenolic resin, polyimide, polyurethane, and/or the like), and/or other like materials; plastics and/or other like materials; composites and/or other like materials; metals, such as zinc, magnesium, titanium, copper, iron, steel, carbon steel, alloy steel, tool steel, stainless steel, spring steel, aluminum, and/or other like materials; and/or any combination of the foregoing.

### EXAMPLES

The following examples are provided to illustrate certain embodiments and experimental observations and are not intended to limit the scope of the disclosure. Unless otherwise indicated, standard wine analytical techniques were used to measure basic chemistry (including pH, titratable acidity (TA), volatile acidity (VA), malic acid, lactic acid, residual sugars (glucose/fructose), ethanol, and glycerol), phenolic chemistry (including total anthocyanins (tANT), free anthocyanins (fANT), bound anthocyanins (bANT), protein-precipitable tannins (pTAN), and iron-reactive phenolics (iRPs)), and color metrics (including CIELab L*, a*, b* and other derived color parameters).

### Experiment Results

### Example 1: Comparative Heat and Electromagnetic Signal Treatments (Tannat Lots)

A 2025 Tannat wine was divided into four lots for comparative evaluation: (i) control, (ii) heat-treated, (iii) heat-treated plus a time-varying electromagnetic signal treatment, as described above, including inductive coupling via an energized conduction ring (hereafter, “TVES”)-treated, and (iv) TVES-treated (control plus electromagnetic signals). Post-treatment, the lots were analyzed for basic chemistry, phenolics chemistry, and color parameters.

Table 1 summarizes basic chemistry results for the four lots. In this study, basic chemistry values were generally consistent across the control and treated lots, and no meaningful increase in volatile acidity (VA) was observed from the short-term heat treatment under the tested conditions.

TABLE 1
Tannat Lot Chemistry

| | | TA | VA | Malic | Lactic | GluFru | Ethanol | Glycerol |
|---|---|---|---|---|---|---|---|---|
| ID | pH | (g/L) | (g/L) | (g/L) | (g/L) | (g/L) | (g/L) | (g/L) |
| Lot #1 Control | 4.21 | 5.24 | 0.72 | 0.14 | 1.79 | 0.40 | 13.25 | 11.02 |
| Lot #2 Heat | 4.20 | 5.20 | 0.74 | 0.12 | 1.77 | 0.67 | 13.18 | 10.75 |
| Lot #3 Heat + TVES | 4.19 | 5.18 | 0.74 | <0.10 | 1.77 | 0.53 | 13.19 | 10.76 |
| Lot #4 Control + TVES | 4.20 | 5.27 | 0.73 | <0.10 | 1.81 | 0.45 | 13.20 | 10.83 |

TABLE 2
Phenolics Chemistry

| | tANT | fANT | bANT | pTAN | iRPs | | |
|---|---|---|---|---|---|---|---|
| ID | (mg/L) | (mg/L) | (mg/L) | (mg/L) | (mg/L) | bANT:pTAN | pTAN:iRPs |
| Lot #1 Control | 591 | 406 | 134 | 532 | 1789 | 0.25 | 0.30 |
| Lot #2 Heat | 562 | 374 | 137 | 503 | 1748 | 0.27 | 0.29 |
| Lot #3 Heat + TVES | 572 | 384 | 137 | 513 | 1755 | 0.27 | 0.29 |
| Lot #4 Control + TVES | 588 | 401 | 135 | 528 | 1793 | 0.26 | 0.29 |

Table 2 summarizes phenolics chemistry results. In this study, phenolic metrics were generally consistent across lots, including tANT, fANT, bANT, pTAN, and iRPs. While measured phenolic values did not show large differences among the conditions, organoleptic (sensory) differences were reported for TVES-treated lots under the tested conditions.

TABLE 3
Color

| ID | L* | a* | b* | I | T |
|---|---|---|---|---|---|
| Lot #1 Control | 64.25 | 31.64 | 5.12 | 0.27 | 0.77 |
| Lot #2 Heat | 64.26 | 31.22 | 6.00 | 0.27 | 0.79 |
| Lot #3 Heat + TVES | 64.00 | 31.61 | 5.45 | 0.28 | 0.78 |
| Lot #4 Control + TVES | 63.99 | 32.10 | 5.51 | 0.28 | 0.77 |

Table 3 summarizes CIELab color metrics and derived color parameters. Under the tested conditions, color intensity was generally consistent across all lots, with a minor change observed in b* (yellow-blue axis) for the heat-treated lot relative to the control.

Additional observations for this study included that free anthocyanins, total anthocyanins, bound anthocyanins, protein-precipitable tannins, and iron-reactive phenolics were consistent across the lots under the tested conditions, while TVES treatment produced noticeable organoleptic changes.

### Example 2: Cabernet Sauvignon Time-Varying Electromagnetic Signal Treatment Trial

In a separate trial, a Cabernet Sauvignon wine was evaluated in a control lot and a TVES-treated lot maintained for approximately 30 days. In this trial, phenolics were reported as generally consistent between the control and TVES treated lots, and no significant increase in volatile acidity or bound anthocyanins was reported under the tested conditions; however, a noticeable and persistent change in aroma and mouthfeel was reported for the TVES-treated lot.

### Example 3: Yeast/Bacteria Panel Evaluation of TVES Treatment

In additional exploratory trials, TVES treatment was evaluated for potential effects on microbial activity and tannin-related sensory characteristics in wine and related products. In one trial directed to yeast and bacteria management, a sterile filtered 750 ml bottle of red wine was inoculated with all the yeast and bacteria on ETS Labs Yeast/Bacteria PCR test. This wine was then divided into a control sample and a TVES-treated sample. The TVES-treated sample was treated for 24 hours, and then both the control and the TVES samples were subjected to microbial evaluation using a yeast and bacteria panel. Additional samples were also retained for later observation and/or follow-up testing.

The panel reported organism-specific counts in cells/mL for multiple microorganisms relevant to wine stability and spoilage, including acetic acid bacteria, L. brevis/hilgardii/fermentum, Lactobacillus plantarum/casei/mali, Lactobacillus kunkeei, Oenococcus oeni, Pediococcus species, Brettanomyces bruxellensis, Saccharomyces cerevisiae, and Zygosaccharomyces species. As shown in Table 4, under the tested conditions, the trial materials reported qualitative changes in microbial populations, including reductions in spoilage-relevant microorganisms such as Brettanomyces and Zygosaccharomyces, while other microorganisms exhibited lesser changes. These observations indicate that the disclosed treatment may be useful as a microbial management tool for wine and related beverages.

TABLE 4
Yeast/Bacteria

| | Control | Treated | |
|---|---|---|---|
| Organism | (cells/mL) | (cells/mL) | Observed Trend |
| Acetic acid bacteria | 29,500 | 30,600 | Slight increase |
| L. brevis/hilgardii/ | 640 | 660 | No significant |
| fermentum | | | change |
| Lactobacillus | 140 | 140 | No significant |
| plantarum/casei/mali | | | change |
| Lactobacillus kunkeei | <10 | <10 | No significant |
| | | | change |
| Oenococcus oeni | 23,200 | 21,900 | Slight reduction |
| Pediococcus species | 20,800 | 19,200 | Slight reduction |
| Brettanomyces | 2,940 | 1,900 | ~36% reduction |
| bruxellensis | | | |
| Saccharomyces | 172,000 | 177,000 | Slight increase |
| cerevisiae | | | |
| Zygosaccharomyces | 7,630 | 5,200 | ~32% reduction |
| species | | | |

Under the tested conditions, the panel results indicated that Brettanomyces bruxellensis was reduced from 2,940 cells/mL in the control to 1,900 cells/mL in the treated sample, corresponding to an approximately 36% reduction, and that Zygosaccharomyces species was reduced from 7,630 cells/mL in the control to 5,200 cells/mL in the treated sample, corresponding to an approximately 32% reduction. The trial materials also characterized acetic acid bacteria as showing a slight increase, Lactobacillus as showing no significant change, Pediococcus as showing a slight reduction, L. brevis/hilgardii/fermentum as showing no significant change, Oenococcus oeni as showing a slight reduction, and Saccharomyces cerevisiae as showing a slight increase.

These results indicate that, under the tested conditions, time-varying electromagnetic signal treatment was associated with measurable reductions in at least certain spoilage-relevant organisms, including Brettanomyces bruxellensis and Zygosaccharomyces species, while other monitored organisms remained generally stable or changed only modestly. The observed reductions in Brettanomyces and Zygosaccharomyces support embodiments in which the disclosed treatment is used as part of a microbial management, stabilization, preservation, and/or spoilage-control process for wine and related beverages.

### Example 4: Tannin Concentrations Under TVES Treatment

In a separate tannin-focused trial, red wine samples were divided into smaller containers and exposed to time-varying electromagnetic signals for approximately one hour, with sensory evaluation performed at approximately 30-minute intervals. Under the tested conditions, no clear change in overall tannin concentration was reported, indicating that the tannins remained present in the treated wine. However, noticeable sensory changes were observed, including a softer profile and a more aromatic character in the treated samples. These observations suggest that the disclosed treatment may influence tannin behavior, perception, and/or interactions within the wine even where total tannin concentration remains generally unchanged.

Without wishing to be bound by theory, the tannin-related changes observed in this trial may reflect changes in tannin activity, polarity, conformation, association, and/or interaction with other wine constituents rather than removal of tannins from the wine. The trial therefore supports embodiments in which the disclosed treatment improves organoleptic properties such as mouthfeel, astringency, texture, and aromatic balance. Further testing may be performed to evaluate the persistence of these effects over time, including whether the observed softening and aromatic enhancement remain stable during storage and aging and whether treatment influences subsequent tannin re-polymerization or aging capacity.

### Example 5: Use of the Analysis Framework for Electromagnetic Treatment

The experimental design, sampling approach, and analysis framework described in Examples 1-4 (including measurement of basic chemistry, phenolics chemistry, color metrics, and organoleptic evaluation) may likewise be used to evaluate embodiments in which a vessel containing wine or spirits is exposed to time-varying electromagnetic signals (for example, via inductive coupling using a conduction ring), including comparative evaluation against control conditions and/or other processing steps.

Furthermore, embodiments of the present disclosure may be manufactured separately and then assembled together, or any or all of the components may be manufactured simultaneously and integrally joined with one another. Manufacture of these components separately or simultaneously, as understood by those of ordinary skill in the art, may involve 3-D printing, extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, and/or the like. If any of the components are manufactured separately, they may then be coupled or removably coupled with one another in any manner, such as with adhesive, a weld, a fastener, any combination thereof, and/or the like for example, depending on, among other considerations, the particular material(s) forming the components.

In places where the description above refers to particular implementations, it should be readily apparent that a number of modifications may be made without departing from the spirit thereof and that these implementations may be applied to other implementations disclosed or undisclosed. The presently disclosed are, therefore, to be considered in all respects as illustrative and not restrictive.

We claim:

1. A method of treating a wine or spirit, the method comprising:
(a) energizing a conduction ring to create electromagnetic signals; and
applying the electromagnetic signals to the wine or spirit, the electromagnetic signals having a frequency in a range of 50 kHz to 300 kHz, wherein the electromagnetic signals improve at least one organoleptic property of the wine or spirit;
wherein the wine or spirit or a vessel containing the wine or spirit is configured to act as at least part of a secondary coil of the conduction ring.

2. The method of claim 1, wherein the organoleptic property is appearance, nose, taste, mouthfeel, finish, texture, aromatic balance, astringency, oak integration, or smoke taint.

3. The method of claim 1, wherein application of the electromagnetic signals to the wine or spirit enhances heat treatment, aging acceleration, and microbial management of the wine or spirit.

4. The method of claim 1, wherein the electromagnetic signals comprise oscillating fields that gradually influence chemical reactions and modify molecular interactions within the wine or spirit.

5. The method of claim 1, wherein energizing the conduction ring comprises generating and amplifying an electromagnetic signal with an amplifier and wirelessly transmitting the electromagnetic signal from a transmitter through an antenna to a receiver, wherein the receiver is conductively coupled to the conduction ring.

6. The method of claim 1, further comprising inducing an electric field in the wine or spirit with an intensity from about 1 V/cm to about 5,000 V/cm.

7. The method of claim 1, wherein the electromagnetic signals are applied to generate a power level in the wine or spirit from about 1 W to about 2,000 W.

8. The method of claim 1, further comprising applying the electromagnetic signals at pre-fermentation before yeast inoculation, at early fermentation, during active fermentation, during mid to late fermentation, at post-fermentation before aging or filtration, at aging and maturation stage, and/or at final processing and bottling.

9. The method of claim 1, further comprising applying the electromagnetic signals to the wine or spirit for an exposure duration of from about 1 second to about 24 hours.

10. The method of claim 1, wherein the wine is red wine, white wine, rose wine, sparkling wine, fortified wine, dessert wine, natural wine, organic wine, biodynamic wine, ice wine, late harvest wine, dry wine, sweet wine, off-dry wine, still wine, orange wine, pét-nat (pétillant naturel) wine, table wine, noble rot wine, botrytized wine, carbonic maceration wine, crianza wine, reserva wine, gran reserva wine, varietal wine, blend wine, vintage wine, or non-vintage wine.

11. The method of claim 1, wherein the spirit is whiskey, bourbon, Scotch whisky, Irish whiskey, rye whiskey, Canadian whisky, Japanese whisky, Tennessee whiskey, moonshine, brandy, Cognac, Armagnac, Calvados, Pisco, grappa, rum, white rum, dark rum, spiced rum, overproof rum, agricole rum, vodka, flavored vodka, gin, London Dry gin, Old Tom gin, Plymouth gin, genever, tequila, mezcal, sotol, raicilla, baijiu, soju, shochu, absinthe, aquavit, ouzo, arak, sambuca, liqueur, amaro, herbal liqueur, cream liqueur, fruit liqueur, nut liqueur, bitters, schnapps, anise-flavored spirits, aperitifs, or digestifs.

12. A system for treating a wine or spirit, the system comprising:
a conduction ring;
an electrical signal source coupled to energize the conduction ring with electromagnetic signals having a frequency in a range of 50 kHz to 300 kHz; and
a secondary coil configured to be at least partially formed by the wine or spirit or a vessel containing the wine or spirit.

13. The system of claim 12, wherein the electromagnetic signals are configured to improve at least one organoleptic property of the wine or spirit, wherein the organoleptic property is appearance, nose, taste, mouthfeel, finish, texture, aromatic balance, astringency, oak integration, or smoke taint.

14. The system of claim 12, wherein energizing the conduction ring generates a time-varying magnetic field configured to induce a voltage/current in the secondary coil; and/or the electromagnetic signals are configured to enhance heat treatment, aging acceleration, and microbial management of the wine or spirit.

15. The system of claim 12, wherein the electromagnetic signals are configured to use oscillating fields that gradually influence chemical reactions to modify molecular interactions within the wine or spirit.

16. The system of claim 12, wherein the electromagnetic signals are created with a transducer comprising a magnetically conductive material passing through the conduction ring.

17. The system of claim 12, wherein the magnetically conductive material is flexible, the electromagnetic signals are configured to inhibit or reduce proliferation of at least one microorganism associated with the wine or spirit, or both.

18. The system of claim 12, wherein at least one conductor forms at least part of the secondary coil and is configured to be immersed in the wine or spirit or coupled to the vessel containing the wine or spirit, wherein the at least one conductor passes through the conduction ring.

19. The system of claim 18, wherein the at least one conductor is two wires, wherein a first wire of the at least two wires is connected to ground and passes through the conduction ring and a second wire of the at least two wires is configured to attach to the vessel containing the wine or spirit or be immersed in the wine or spirit.

20. A method of treating a wine or spirit, comprising:
(a) positioning a vessel containing the wine or spirit relative to a conduction ring;
(b) energizing the conduction ring with an alternating electrical signal having a frequency in a range of about 50 kHz to about 300 kHz to generate a time-varying electromagnetic field; and
(c) inductively coupling energy from the conduction ring into a secondary conductive path at least partially defined by the wine or spirit and/or the vessel,
whereby at least one organoleptic property is improved and/or microbial proliferation is inhibited.
